(19) United States
(12) Patent Application Publication
(10) Pub. No.: US 2015/0023039 A1
(43) Pub. Date: Jan. 22, 2015

(54) VEHICLE LAMP

(71) Applicant: SL Corporation, Daegu (KR)

(72) Inventors: Junhyung Seo, Gyeongsan (KR); Jin Young Jung, Gyeongsan (KR); Giman Park, Gyeongsan (KR)

(73) Assignee: SL Corporation

(21) Appl. No.: 14/333,216

(22) Filed: Jul. 16, 2014

(30) Foreign Application Priority Data
Jul. 16, 2013 (KR) 10-2013-0083311
Jul. 19, 2013 (KR) 10-2013-0085131

(51) Int. Cl. F21S 8/10

(52) U.S. Cl. CPC F21S 48/145
USPC 362/516

(57) ABSTRACT

A vehicle lamp is provided that forms a predetermined image using a leaked portion of light generated by a light source. The vehicle lamp includes a light source and a light image forming part that is configured to form an image of a predetermined shape using light emitted from the light source. In addition, a reflector is configured to form a beam pattern by reflecting the light of the light source to a certain area and guide the light of the light source to the light image forming part disposed in front of the light source by reflecting the light of the light source to another area.

### CROSS REFERENCE TO RELATED APPLICATION

This application claims priority from Korean Patent Application No. 10-2013-0083311 filed on Jul. 16, 2013 and No. 10-2013-0085131 filed on Jul. 19, 2013, which applications are incorporated herein by reference in its entirety.

### BACKGROUND

1. Field of the Invention

The present invention relates to an automotive lamp, and more particularly, to an automotive lamp that forms a predetermined image using a leaked portion of light generated by a light source.

2. Description of the Related Art

Generally, a vehicle includes a lamp module having a lighting function and a signaling function. In other words, the lamp module enables the driver of the vehicle to detect objects around and ahead of the vehicle while driving at night or in a dark area (e.g., during poor lighting conditions). The lamp module also informs other vehicles and road users of the vehicle's driving state. For example, a headlamp and a fog lamp are designed for the lighting function, and a direction indicator, a taillight, a brake light and a side marker are designed for the signaling function.

Currently, the lamp module does not simply provide the lighting function and the signaling function. The lamp module also improves visibility by emitting light of a predetermined shape and increases recognition of a particular products. Changing the shape of light emitted extraneously is a technology that has been used from a long time ago. Therefore, it may be difficult for a product using this technology to be differentiated from other products.

### SUMMARY

It is an objective of the present invention to form a predetermined image using a leaked portion of light generated by a light source. It is another objective of the present invention to form an image using one light source in a similar manner to using a plurality of light sources. However, the objectives of the present invention are not restricted to the one set forth herein. The above and other objectives of the present invention will become more apparent to one of ordinary skill in the art to which the present invention pertains by referencing a detailed description of the present invention given below.

According to an aspect of the present invention, an automotive lamp may include: a light source; a light image forming part that forms an image of a predetermined shape using light of the light source; and a reflector that forms a beam pattern by reflecting the light of the light source to a certain area and guides the light of the light source to the light image forming part located ahead by reflecting the light of the light source to another area.

### BRIEF DESCRIPTION OF THE DRAWINGS

The above and other aspects and features of the present invention will become more apparent by describing in detail exemplary embodiments thereof with reference to the attached drawings, in which:

FIG. 1 is an exemplary detailed view of an automotive lamp according to a first exemplary embodiment of the present invention;

FIG. 2 is an exemplary view of the automotive lamp according to the first exemplary embodiment of the present invention;

FIG. 3 is an exemplary front view of the automotive lamp according to the first exemplary embodiment of the present invention;

FIGS. 4 and 5 illustrate an exemplary vehicle equipped with the automotive lamp according to the first exemplary embodiment of the present invention;

FIG. 6 is an exemplary plan view of the automotive lamp according to the first exemplary embodiment of the present invention;

FIGS. 7 and 8 are exemplary side views of the automotive lamp according to the first exemplary embodiment of the present invention;

FIG. 9 illustrates an exemplary process of forming an image according to the first exemplary embodiment of the present invention;

FIG. 10 illustrates an exemplary light output module and a light source module included in an automotive lamp according to a second exemplary embodiment of the present invention;

FIG. 11 illustrates an exemplary light output part and a light blocking member included in the light output module of the automotive lamp according to the second exemplary embodiment of the present invention;

FIG. 12 is an exemplary plan view of the automotive lamp according to the second exemplary embodiment of the present invention;

FIG. 13 is an exemplary front view of the automotive lamp according to the second exemplary embodiment of the present invention;

FIG. 14 is an exemplary view of the light output module according to the second exemplary embodiment of the present invention;

FIGS. 15 through 17 illustrate exemplary light of a light source which is incident upon the light output part according to the second exemplary embodiment of the present invention;

FIG. 18 is an exemplary detailed view of the light output module according to the second exemplary embodiment of the present invention;

FIG. 19 illustrates an exemplary headlamp equipped with the automotive lamp according to the second exemplary embodiment of the present invention; and

FIGS. 20 and 21 illustrate the exemplary automotive lamp viewed from in front of a vehicle according to the second exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Advantages and features of the present invention and methods of accomplishing the same may be understood more readily by reference to the following detailed description of exemplary embodiments and the accompanying drawings. The present invention may, however, be embodied in many different forms and should not be construed as being limited to the embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

An automotive lamp according to the present invention may be configured to provide a beam pattern and also an image of a predetermined shape. Specifically, when light is incident upon a transparent or semitransparent light image forming part, an image that corresponds to an exposed portion of the light image forming part may be formed. Light emitted from a light source may be reflected by a reflector, and the reflected light may be used to form a beam pattern and an image. The reflector may be configured to form a beam pattern by reflecting the light of the light source to a certain area and guiding the light of the light source to the light image forming part placed ahead (e.g., disposed in front of the light source) by reflecting the light of the light source to another area.

The beam pattern may include a low-beam pattern. The automotive lamp may form both a low-beam pattern and an image using only one light source. In particular, the low-beam pattern may be formed by intentionally outputting light of the light source to the exterior, and the image may be formed by unintended light of the light source. In other words, of light generated by the light source, a portion not used to form a beam pattern may be used to form an image. For example, the image may be formed by leaked light. In addition, to make the image clearer, a portion of light of the light source may be intentionally made (e.g., may be guided) to enter the light image forming part. An image exposed to the exterior may have a predetermined shape such as a “U” shape. The “U” shape may be an image composed of one portion or a plurality of portions. In any case, the automotive lamp of the present invention may include one light source.

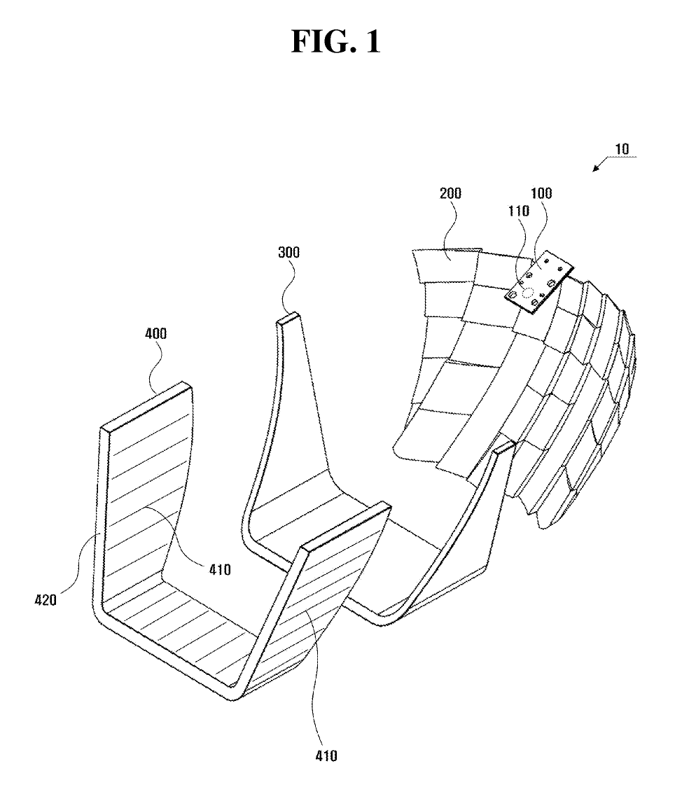

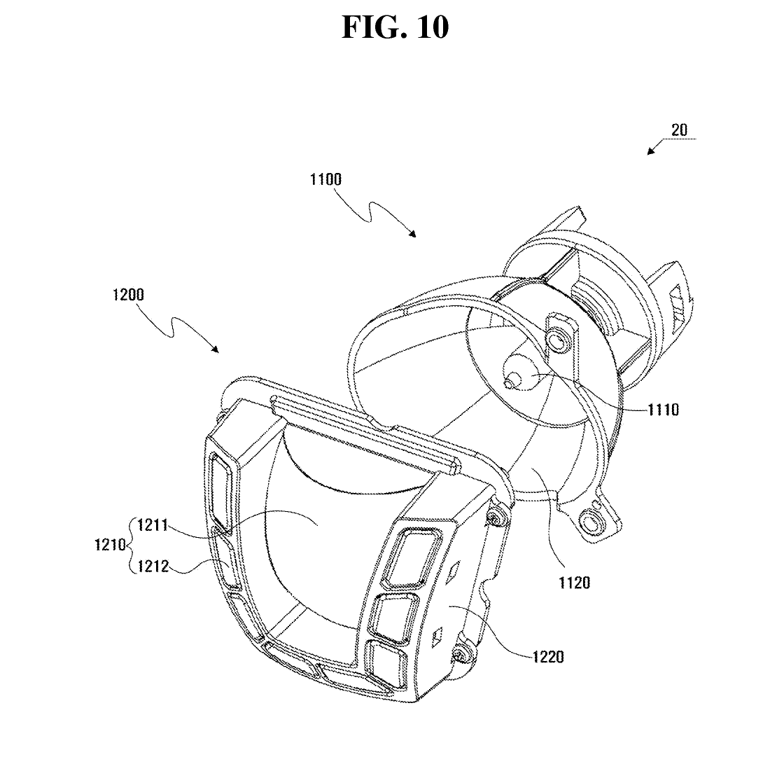

Hereinafter, an automotive lamp that forms an image composed of one portion (e.g., is not formed of a plurality of different image portions) will be described with reference to FIGS. 1 through 9, and an automotive lamp that forms an image composed of a plurality of portions will be described with reference to FIGS. 10 through 21.

FIG. 1 is an exemplary detailed view of an automotive lamp 10 according to a first exemplary embodiment of the present invention. The automotive lamp 10 of the present invention may include a light source module 100, a reflector 200, a support 300, and a light image forming part 400. The light source module 100 may be configured to generate light such that the light is irradiated along an optical axis. Accordingly, the light source module 100 may include a light source 110. In FIG. 1, the light source module 100 may include the light source 110 and a light source panel having the light source 110 attached to a bottom surface thereof.

However, the light source module 100 of the present invention does not necessarily consist of the light source 110 and the light source panel. The light source module 100 may include the light source 110 only. In addition, a part to which the light source 110 is attached is not necessarily in the form of a panel but may be various forms. In the present invention, the light source 110 may be a light source such as a light-emitting diode (LED) configured to form a directional beam pattern. However, when a light source (such as a bulb) that forms a non-directional beam pattern is used, a reflective plate (not illustrated) or a lens (not illustrated) configured to convert the non-directional beam pattern into a directional beam pattern may be included in the light source module 100.

The reflector 200 may be configured to reflect light generated by the light source 110 and guide the reflected light to a desired position. The reflected light may be used to form a beam pattern, and a portion of the reflected light may be guided to the light image forming part 400 (e.g., not all of the light may form a beam patter). The reflector 200 may be disposed adjacent to the light source module 100 and may have a predetermined curvature to secure a reflection path of light generated by the light source 110.

In the present invention, the reflector 200 may cause rays of light generated by the light source 110 to be irradiated in the same direction regardless of where in the reflector 200 the rays of light are reflected. Accordingly, a reflective surface of the reflector 200 may be a parabolic curved surface. In other words, the light source 110 may be disposed at a focus of the parabolic curved surface. Thus, when rays of light generated by the light source 110 are reflected by the reflective surface of the reflector 200, all of the reflected rays of light may be irradiated parallel to each other. In addition, the reflector 200 of the present invention may consist of a plurality of reflective plate pieces, each having a planar shape as illustrated in FIG. 1. When the reflector 200 consists of the reflective plate pieces, a direction in which a ray of light generated by one light source 110 is irradiated may vary according to the position of a reflective plate piece by which the ray of light is reflected. In other words, light reflected at a certain position in a reflection area formed by one reflective plate piece and light reflected at another position in the reflection area may be irradiated in different directions.

When light emitted from the light source 110 is reflected at a substantial center of each of the reflective plate pieces, the reflected light may be irradiated in about the same direction with respect to all of the reflective plate pieces. In other words, when the reflector 200 has a parabolic curved surface and the light source 110 is disposed at the focus of the parabolic curved surface, almost all rays of the reflected light may be irradiated parallel to each other. In addition, the rays of the reflected light may be irradiated in about the same direction by allowing the centers of the reflective plate pieces to contact the parabolic curved surface. However, the arrangement of the reflective plate pieces included in the reflector 200 of the present invention is not limited to the above example, and the centers of all or some of the reflective plate pieces may not contact the parabolic curved surface. When the centers of all or some of the reflective plate pieces do not contact the parabolic surface, the rays of the reflected light may be irradiated in more diverse directions.

As described above, rays of light reflected by one parabolic curved surface or a plurality of reflective plate pieces may be irradiated in the same or similar direction. When the automotive lamp 10 is a headlamp, the reflected rays of light may form a low-beam pattern. The light image forming part 400 may be configured to form an image of a predetermined shape using direct light or reflected light of the light source 110. The light image forming part 400 may be a transparent or semitransparent photoconductive member. As light is incident upon the light image forming part 400 (i.e., a photoconductive member), an observer may perceive light of a predetermined shape formed in the light image forming part 400.

The low-beam pattern described above may be formed by reflected light. Direct light and reflected light of the light source 110 which enter the light image forming part 400 include light not used to form the low-beam pattern, that is, leaked light. In other words, even when light of the light source 110 has a directional pattern, the light may be irradiated in an unintended direction due to various factors. Therefore, not all rays of light directly generated by the light source 110 of the present invention or not all rays of light reflected by the reflector 200 may be used to form the low-beam pattern. Thus, the light image forming part 400 of the present invention may be configured to form an image using leaked light that may not be used to form the low-beam pattern. Accordingly, a light source that forms an image may be omitted, and a part that prevents the leaked light from being emitted to the exterior may also be omitted.

In addition, since the centers of some or all of the reflective plate pieces of the reflector 200 do not contact the parabolic curved surface as described above, rays of reflected light may be irradiated in more diverse directions. In particular, the amount of light entering the light image forming part 400 may increase, which, in turn, may increase the image forming effect of the light image forming part 400. The light image forming part 400 may be configured to form an image of a predetermined shape using light transforming portions 410 and 420 included in the surface or inside thereof. The light transforming portions 410 and 420 may include at least one of light refracting patterns, scratches, and paint. Further, in FIG. 1, the light image forming part 400 may include light refracting patterns or scratches in the form of substantially straight lines, and a vertical cross section of the light image forming part 400 may be covered with paint (e.g., may be coated with paint or may be painted). The paint may be white, but the present invention is not limited thereto, and various colors may be used. When colored paint is used (e.g., paint that is not white), the color of the light source 110 and the color of the paint may be mixed to determine the color of an image.

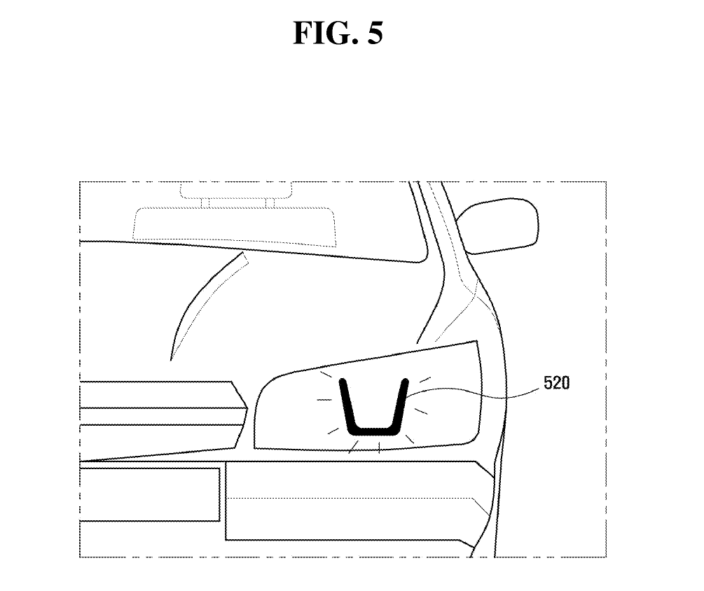

When light of the light source 110 is incident upon the light image forming part 400, the light may travel inside the light image forming part 400 while being reflected along the surface of the light image forming part 400. Then, when the light reaches the light transforming portions 410 and 420, the light may be refracted or scattered to form a predetermined pattern having a higher or lower luminance level than other portions. Additionally, an image formed by the light image forming part 400 may include a surface emission image 520. The light image forming part 400 may be shaped like a plate having a predetermined thickness. As illustrated in FIG. 5, the surface emission image 520 may be formed by paint applied along the vertical cross section of the plate. In particular, the surface emission image 520 may be formed using direct light or reflected light of the light source 110 which enters the surface or side surfaces of the plate of the light image forming part 400.

The light image forming part 400 of the present invention is not limited to the plate shape and may be formed in various shapes. In FIG. 1, the light transforming portion 420 which forms the surface emission image 520 may be “U”-shaped, and the light transforming portion 410 included in the light image forming part 400 may be formed as substantially straight lines. However, this is merely an example, and the light transforming portions 410 and 420 may be formed in various shapes. In other words, various images may be formed by the light image forming part 400. The plate-shaped light image forming part 400 having a predetermined thickness may form an image using an optic formed on the surface of the plate. In particular, the optic may be formed by at least one of the light refracting patterns and the scratches. In FIG. 1, linear patterns formed by linear scratches are illustrated.

Ultimately, in the present invention, an image may be formed on the light image forming part 400 using light of the light source 110 refracted by the light refracting patterns or scattered by the scratches or the paint. The image may include a linear pattern, a curved pattern, a polygonal pattern or a surface pattern. The support 300 may be configured to support the reflector 200. In the present invention, the reflector 200 may be shaped as a substantially thin plate that may be deformed by external impact. Thus, the support 300 may be configured to fix both sides of the reflector 200, to prevent the reflector 200 from being deformed by external impact. In addition, a side of the support 300 may be coupled to a side of the light image forming part 400, thereby connecting the reflector 200 and the light image forming part 400. When the reflector 200 is made of a substantially hard material or when the reflector 200 and the light image forming part 400 are bonded directly to each other, the support 300 may be omitted.

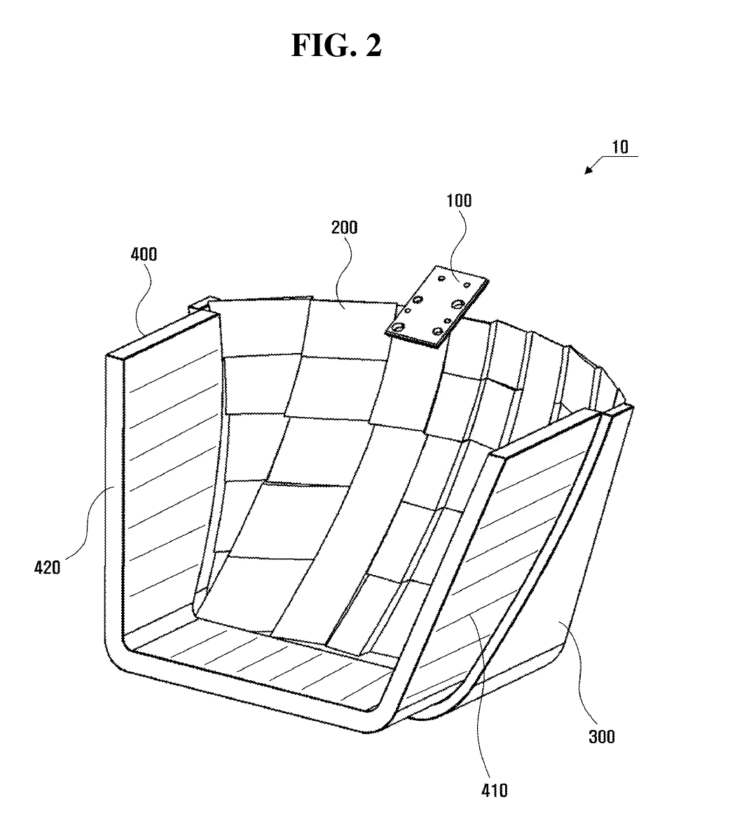

FIG. 2 is an exemplary view of the automotive lamp 10 according to the first exemplary embodiment of the present invention. In FIG. 2, a side of the light image forming part 400 may contact (e.g., may touch, come in contact with, may abut to) the reflector 200, and the support 300 may be configured to connect the light image forming part 400 and the reflector 200. The light transforming portions 410 and 420 may be included in the surface or inside of the light image forming part 400. When light directly emitted from the light source 110 of the light source module 100 or light reflected by the reflector 200 is incident upon the light image forming part 400, a predetermined image may be formed by the light transforming portions 410 and 420.

In FIG. 2, the light transforming portion 410 may be formed as substantially straight lines inside the light image forming part 400. Accordingly, a plurality of linear images may be formed along the inside of the light image forming part 400. In addition, a “U”-shaped image may be formed on the vertical cross section of the light image forming part 400 by the “U”-shaped light transforming portion 420.

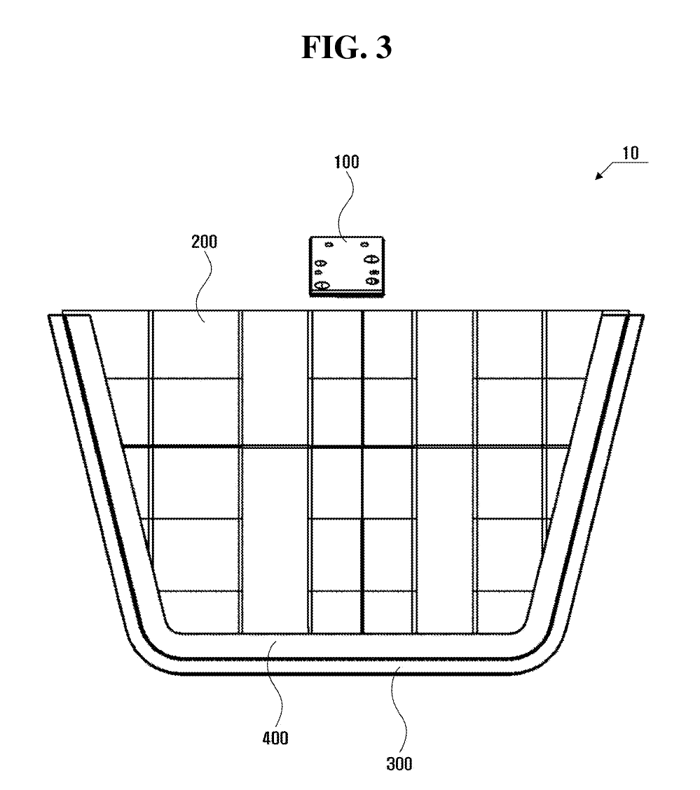

FIG. 3 is an exemplary front view of the automotive lamp 10 according to the first exemplary embodiment of the present invention. Light reflected by the reflector 200 may form a low-beam pattern described above, and light incident upon the light image forming part 400 may form an image of a predetermined shape. In FIG. 3, a case where a “U”-shaped image is formed is illustrated.

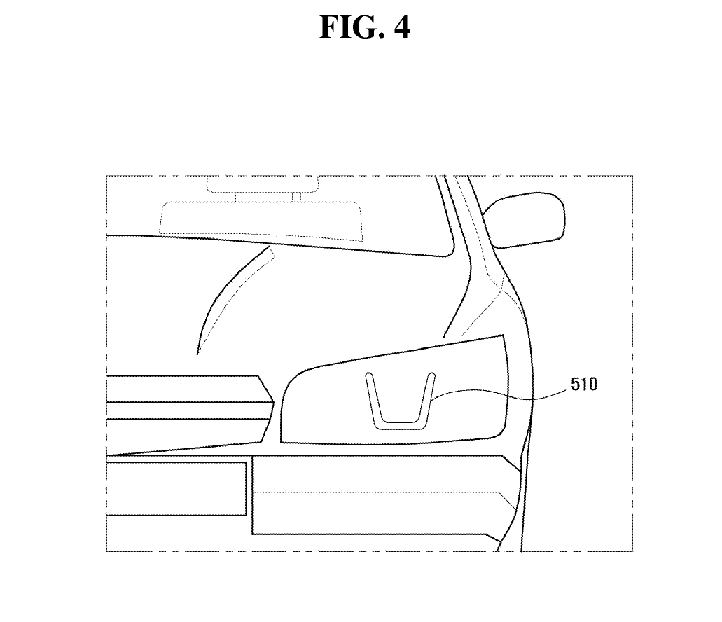

FIGS. 4 and 5 illustrate an exemplary vehicle equipped with the automotive lamp 10 according to the first exemplary embodiment of the present invention. In FIGS. 4 and 5, the automotive lamp 10 may operate as a headlamp. Specifically, FIG. 4 illustrates the automotive lamp 10 turned off, and FIG. 5 illustrates the automotive lamp 10 turned on. A surface emission image 510 of the automotive lamp 10 turned off is not clear, but a “U”-shaped surface emission image 520 of the automotive lamp 10 turned on is clearer. Although not illustrated in FIG. 5, a low-beam pattern may be formed together with the surface emission image 520 by the automotive lamp 10. A combination of the low-beam pattern and the surface emission image 520 provides a different appearance from those provided by other automotive lamps.

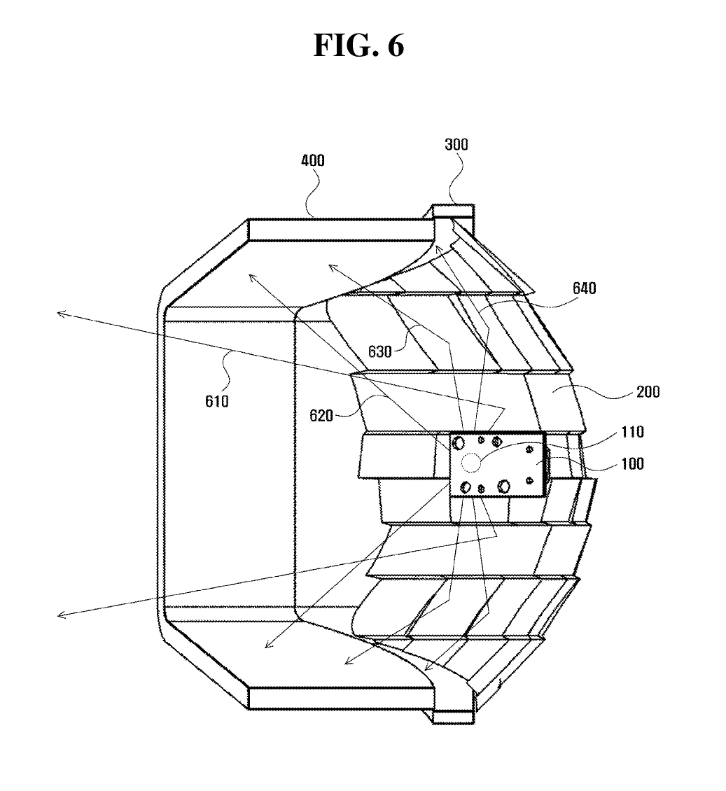

FIG. 6 is an exemplary view of the automotive lamp 10 according to the first exemplary embodiment of the present invention. In FIG. 6, light of the light source 110 may be irradiated to form a beam pattern or may be incident upon the light image forming part 400 to form an image. The light image forming part 400 may be shaped as a plate having a predetermined thickness, and side surfaces of the light image forming part 400 may be disposed adjacent to edges of the reflector 200. Direct light or reflected light of the light source 110 may be incident upon the surface or side surfaces of the plate of the light image forming part 400 to form an image.

In other words, a portion 610 of light 610, 630 and 640 reflected by the reflector 200 may be irradiated to the front and used to form a beam pattern, and the other portions 630 and 640 of the reflected light may be incident upon the light image forming part 400 and used to form an image. In particular, light incident upon the light image forming part 400 may include the reflected light 630 and 640 and also direct light 620. In other words, light generated by the light source 110 may be directly incident upon the light image forming part 400 without being reflected by the reflector 200.

The light image forming part 400 of the present invention may be shaped as a plate bent in the shape of “U.” Light of the light source 110 may enter the surface of the plate or the side surfaces of the plate to form various images including the surface emission image 520. The light of the light source 110 may include the direct light 620 and the reflected light 630 and 640. To guide light to enter the side surfaces of the plate, the light image forming part 400 may contact (e.g., may abut) the support 300 with a step therebetween (e.g., may be spaced apart), and the side surfaces of the plate-shaped light image forming part 400 that contacts the support 300 may be included in the substantially entire area of the reflector 200. Accordingly, light of the light source 110 may enter the side surfaces of the light image forming part 400, which, in turn, enables a clearer image to be formed by the light transforming portions 410 and 420.

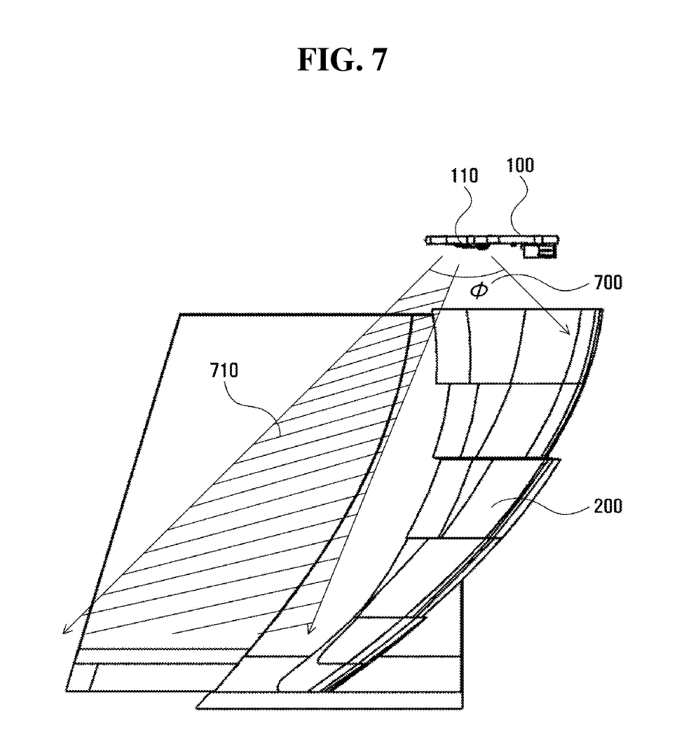

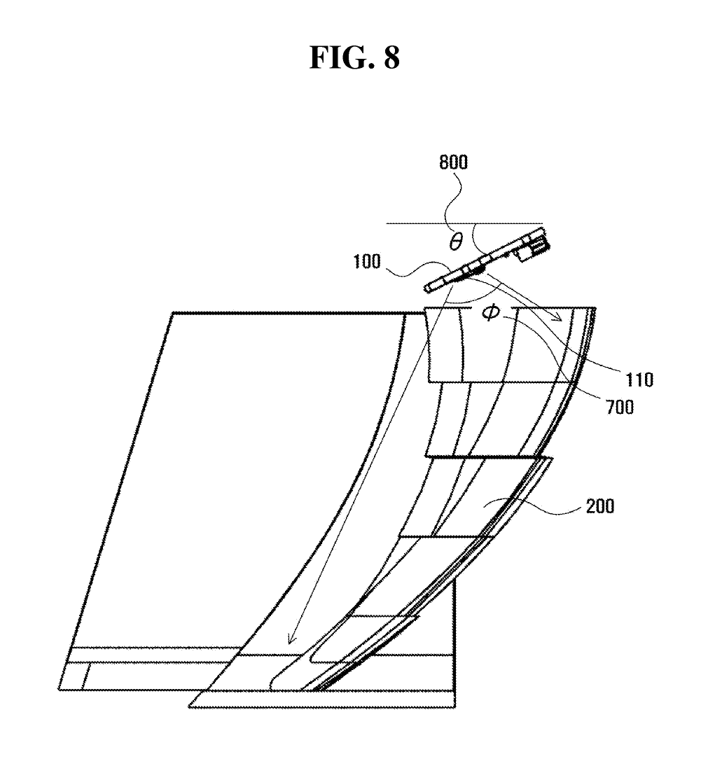

FIGS. 7 and 8 are exemplary side views of the automotive lamp 10 according to the first exemplary embodiment of the present invention. In FIGS. 7 and 8, reflection efficiency according to the irradiation direction of the light source 110 is illustrated. As described above, the light source 110 of the present invention may be a light source (such as an LED) configured to form a directional beam pattern. Light generated by such a light source 110 may have a certain irradiation angle range 700. In other words, light may be irradiated at an angle within the irradiation angle range 700 as illustrated in FIG. 7. Referring to FIG. 7, when light of the light source 110 is irradiated to the reflector 200 having a predetermined parabolic curved surface, light 710 in a shaded area may be wasted since the light is not irradiated to the reflector 200. The light 710 not irradiated to the reflector 200 may be delivered to the light image forming part 400 and used to form an image. However, the luminance of a low beam may be reduced. Therefore, a directional angle 800 of the light source 110 with respect to the reflector 200 according to the first exemplary embodiment of the present invention may be determined in view of the irradiation angle range 700 of the light source 110.

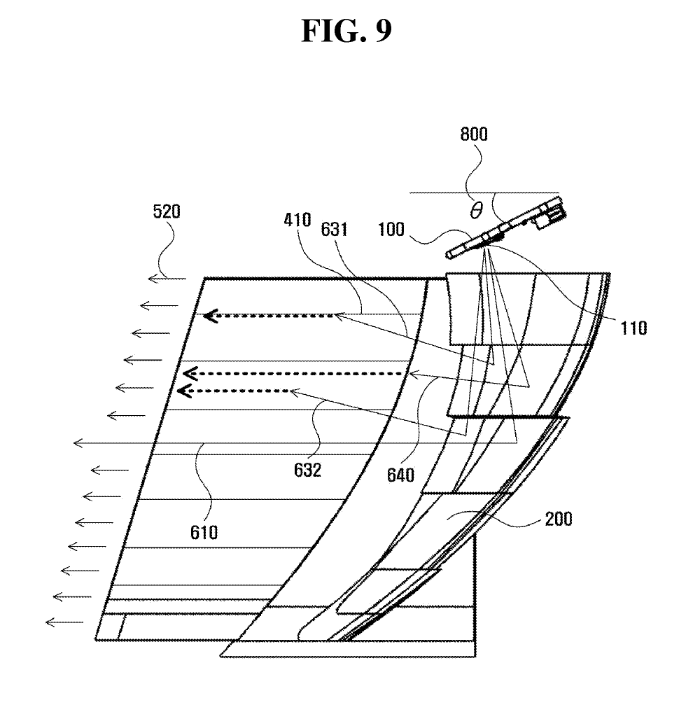

Referring to FIG. 8, the directional angle 800 of the light source 110 may be determined in view of the irradiation angle range 700 of the light source 110 and the position of the reflector 200. Since most rays of light within the irradiation angle range 700 of the light source 110 may propagate toward the reflector 200, the luminance of the low beam may be increased. FIG. 9 illustrates an exemplary process of forming an image according to the first exemplary embodiment of the present invention. Light of the light source 110 may be reflected by the reflector 200 to form a beam pattern or may be incident upon the light image forming part 400 to form an image.

Further, a portion 610 of light 610, 631, 632 and 640 reflected by the reflector 200 may be irradiated to the front and used to form a beam pattern, and the other portions 631, 632 and 640 of the reflected light may be incident upon the light image forming part 400 and used to form an image. In particular, the light 631, 632 and 640 incident upon the light image forming part 400 may travel inside the light image forming part 400 while being reflected along the surface of the light image forming part 400. Then, when the light 631, 632 and 640 reaches the light transforming portions 410 and 420, the light 631, 632, and 640 may be refracted or scattered to have a higher or lower luminance level than other portions.

In FIG. 9, a case where the reflected light 631, 632 and 640 is incident upon the surface or side surfaces of the light image forming part 400 is illustrated. The incident light 631, 632 and 640 may reach the light transforming portion 410 inside the light image forming part 400 to form a linear image or reach the vertical cross section to form the surface emission image 520.

Moreover, to cause the light 631, 632 and 640 to be incident upon the light image forming part 400 be reflected by the inside surface of the light image forming part 400 to reach the light transforming portions 410 and 420 without completely transmitting through the light image forming part 400, the surface of the light image forming part 400 may be coated such that light may substantially freely enter the surface without escaping (e.g., leaking) from the surface.

Described thus far herein includes a case where a main image exposed to the outside is a “U”-shaped image. In particular, the image is composed of only one portion. However, a plurality of portions may also combine to form one image. An automotive lamp that forms an image composed of a plurality of portions will now be described.

FIG. 10 illustrates an exemplary light output module 1200 and a light source module 1100 included in an automotive lamp 20 according to a second exemplary embodiment of the present invention. Referring to FIG. 10, the automotive lamp 20 may include the light source module 1100 and the light output module 1200. The light source module 1100 may include a light source 1110 and a reflector 1120 configured to reflect light generated by the light source 1110.

The light source 1110 may be a light-emitting module configured to generate light and may be a projection-type light source. A projection-type headlamp may be configured to focus light at one point (e.g., at a single point). Thus, the projection-type headlamp may be more advantageous in light distribution effect than a general clear-type headlamp and may also provide a sporty appearance to the front of a vehicle. For example, the light source 1110 may consist of a discharge bulb and a light-emitting unit configured to emit light due to the discharge bulb. The discharge bulb may be, for example, a metal halide bulb. The reflector 1120 may be configured to reflect light emitted from the light source 1110 to a desired position. The reflector 1120 may be formed adjacent to the light source 1110 and may be, but is not limited to, semispherical as illustrated in FIG. 10 to secure a reflection path of generated light.

A diffused reflection layer or a diffusion layer may be formed on a surface of the reflector 1120. In other words, light emitted from the light source 1110 may be diffusely (irregularly) reflected by the reflector 1120 such that the evenly spread light may propagate out of the automotive lamp 20 through a light output part 1210 at the front. In particular, similar to light emitted from a surface light source, the light output through the light output part 1210 may show, on the whole, a substantially uniform luminance distribution. The diffused reflection layer formed on the surface of the reflector 1120 may include a repeated pattern of fine protrusions and recesses. As light is irregularly reflected by the fine protrusions and recesses, it may have, on the whole, substantially uniform luminance.

The light output module 1200 may include the light output part 1210 and a light blocking member 1220. As described above, the light output part 1210 may be configured to refract light of the light source 1110 toward the front of the vehicle. Accordingly, the light output part 1210 may be implemented as a convex or concave lens having a focus. In the present invention, the light output part 1210 may include a beam pattern forming part 1211 and a light image forming part 1212 which form different light patterns. Thus, the light output part 1210 may be configured to transmit different portions of light emitted from the light source 1110 through different light output portions, respectively.

In particular, the beam pattern forming part 1211 and the light image forming part 1212 may be different portions of the light output part 1210 separated and may receive light from the light source 1110. The movement of light between the beam pattern forming part 1211 and the light image forming part 1212 may be blocked by a difference in medium between a surface of the beam pattern forming part 1211 and a surface of the light image forming part 1212 which may contact each other. The light blocking member 1220 may also block the movement of light between the beam pattern forming part 1211 and the light image forming part 1212.

In the present invention, the beam pattern forming part 1211 may be configured to receive light from the light source 1110 and form a beam pattern, and the light image forming part 1212 may be configured to form an image different from the beam pattern. Specifically, the beam pattern may include a low-beam pattern. In other words, the beam pattern forming part 1211 may be configured to secure a driver's forward visibility at night, and the light image forming part 1212 may be configured to provide an image of a predetermined shape around the beam pattern forming part 1211 instead of securing visibility.

The light output part 1210 of the present invention may include a plurality of light output portions. One of the light output portions may be configured to form the beam pattern forming part 1211, and the other portions may be configured to form the light image forming part 1212. A light output portion disposed at a substantial center of the light output module 1200 illustrated in FIG. 10 may correspond to the beam pattern forming part 1211, and a plurality of light output portions arranged along edges of the beam pattern forming part 1211 may correspond to the light image forming part 1212.

When the light output part 1210 is divided into a plurality of light output portions and when the movement of light between the light output portions is blocked as described above, even when light is emitted from one light source 1110, an observer may perceive the light as being emitted from a plurality of light sources respectively provided for the light output portions. For example, even when one bulb light source is employed, an image may be formed as if a plurality of LED light sources were employed. Therefore, while the light source module 1100 according to the current exemplary embodiment includes one light source 1110, the present invention is not limited thereto. That is, a plurality of light sources may be included in the light source module 1100.

Even when a plurality of light sources are included in the light source module 1100, light generated by a particular light source may not be incident upon a particular light output portion. The light generated by a plurality of light sources may be distributed substantially evenly and incident upon each of the light output portions. Most of light generated by a particular light source may be guided to enter a particular light output portion. Even in this case, however, a portion of the light generated by the particular light source may also enter other light output portions.

As described above, the beam pattern forming part 1211 may be configured to form a low-beam pattern. Accordingly, a substantial portion of light generated by the light source 1110 may be incident upon the beam pattern forming part 1211. However, of the light generated by the light source 1110, a portion (i.e., leaked light) not used to form the low-beam pattern may enter the light image forming part 1212 and may be configured to transmit through the light image forming part 1212 to form an image. Accordingly, the automotive lamp 20 according to the second exemplary embodiment of the present invention may omit a part for preventing the leaked light from being emitted to the exterior or a part for forming an image.

Furthermore, according to the second exemplary embodiment of the present invention, the color of light that transmits through the beam pattern forming part 1211 and the color of light that transmits through the light image forming part 1212 may be different from each other. For example, the light output part 1210 may be manufactured to contain a color. Specifically, a color contained in the beam pattern forming part 1211 and a color contained in the light image forming part 1212 may be different, or films of different colors may be attached to the beam pattern forming part 1211 and the light image forming part 1212.

Alternatively, no color may be reflected in the beam pattern forming part 1211, and the light image forming part 1212 may contain a particular color or may have a film attached thereto such that light of the particular color may be irradiated. Additionally, each of the light output portions that form the light image forming part 1212 may have a different color. As described above, the light source 1110 of the present invention may be a bulb. When turned on, the bulb light source generates substantially high heat, thus discoloring or deforming the light output part 1210. Accordingly, the beam pattern forming part 1211 and the light image forming part 1212 according to the second exemplary embodiment of the present invention may be made of silicon. Thus, even when the bulb light source generates substantially high heat, the beam pattern forming part 1211 and the light image forming part 1212 made of a silicon material may be prevented from being discolored or deformed.

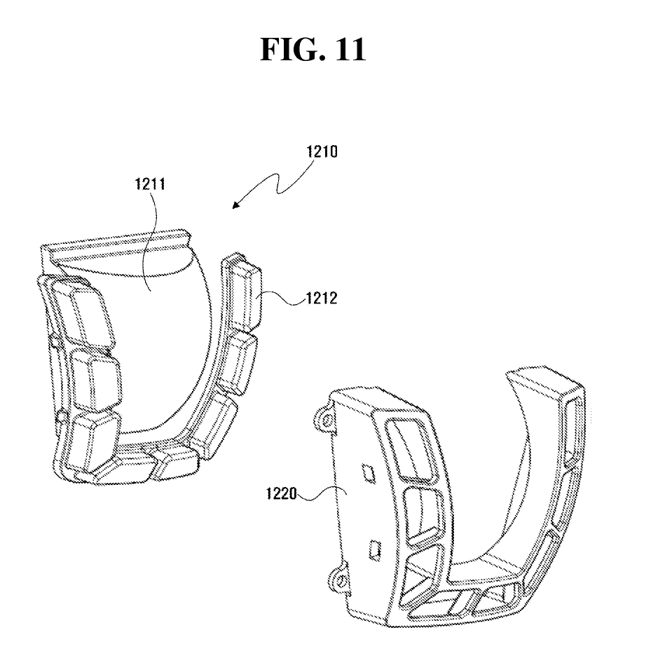

FIG. 11 illustrates the exemplary light output part 1210 and the light blocking member 1220 included in the light output module 1200 of the automotive lamp 20 according to the second exemplary embodiment of the present invention. Referring to FIG. 11, the light output part 1210 may include the beam pattern forming part 1211 and the light image forming part 1212. The beam pattern forming part 1211 and the light image forming part 1212 may be separated from each other as illustrated in FIG. 11. However, the structure of the light output part 1210 of the present invention is not limited to the above example. The light output part 1210 may also include the beam pattern forming part 1211 and the light image forming part 1212 formed as a single part. Alternatively, the light output part 1210 may include each of the light output portions that form the light image forming part 1212 as a separate portion.

The light blocking member 1220 may be configured to accommodate the beam pattern forming part 1211 and the light image forming part 1212 of the light output part 1210. The light output portions may be separated by a bather rib of the light blocking member 1220. Accordingly, even when light incident upon a particular light output portion is scattered in the particular light output portion, since the scattered light may be reflected by the barrier rib, is the light may be output to the exterior through the particular light output portion without propagating to other light output portions. Accordingly, the barrier rib of the light blocking member 1220 may be made of an opaque material that does not transmit light. In addition, outer sidewalls of the light blocking member 1220 which surrounds the exterior of the light image forming part 1212 may be made of an opaque material that does not transmit light. Accordingly, light incident upon the light image forming part 1212 may be emitted to the front of the light image forming part 1212.

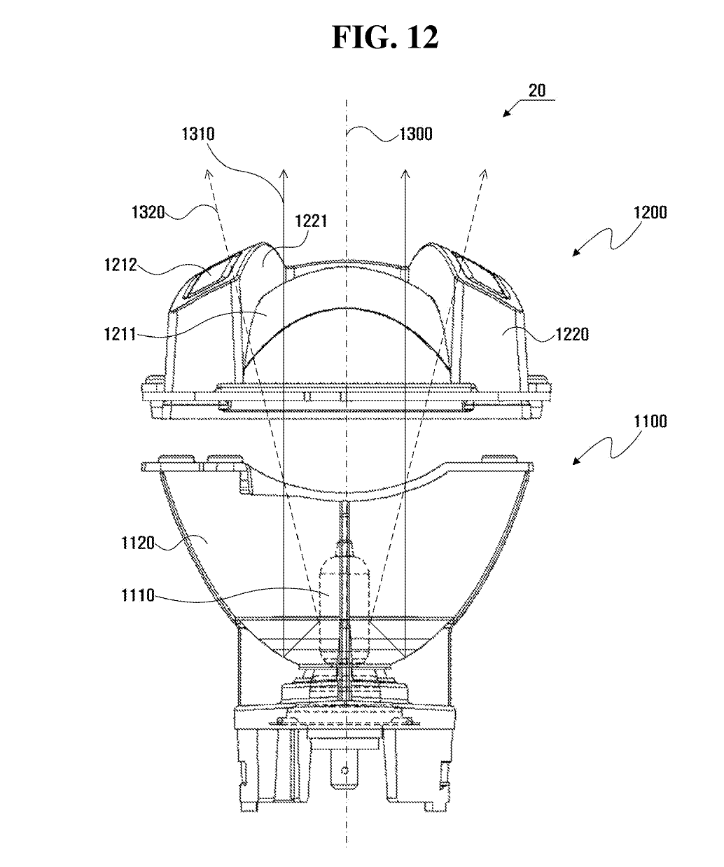

FIG. 12 is an exemplary plan view of the automotive lamp 20 according to the second exemplary embodiment of the present invention. Referring to FIG. 12, when light generated by the light source 1110 reaches the reflector 1120, the light may be reflected by the reflector 1120 toward the light output part 1210. In particular, when the inside of the reflector 1120 is a parabolic curved surface and when the light source 1110 is located at a focus of the parabolic curved surface, the reflected light 1310 may be irradiated to the light output part 1210 in a direction substantially parallel to an optical axis 1300 regardless of where in the reflector 1120 the light 1310 has been reflected.

Meanwhile, a portion of the light generated by the light source 1110 may also be directly irradiated to the light output part 1210 without travelling to the reflector 1120. This light 1320 directly irradiated to the light output part 1210 may reach the light output part 1210 at a certain angle to the optical axis 1300. A plurality of light output portions may exist on an irradiation path of light having an angle to the optical axis 1300. However, the light may be output to the exterior through the first light output portion upon which the light is incident and may be blocked by a barrier rib 1221 of the light blocking member 1220 from reaching the other light output portions.

In FIG. 12, the beam pattern forming part 1211 and the light image forming part 1212 may exist on an irradiation path of the direct light 1320 of the light source 1110. The barrier rib 1221 provided between the beam pattern forming part 1211 and the light image forming part 1212 may be configured to prevent the direct light 1320 irradiated to the beam pattern forming part 1211 from reaching the light image forming part 1212. The direct light 1320 may be reflected by the barrier rib 1221 to be emitted to the exterior through the beam pattern forming part 1211 or may be absorbed by the barrier rib 1221.

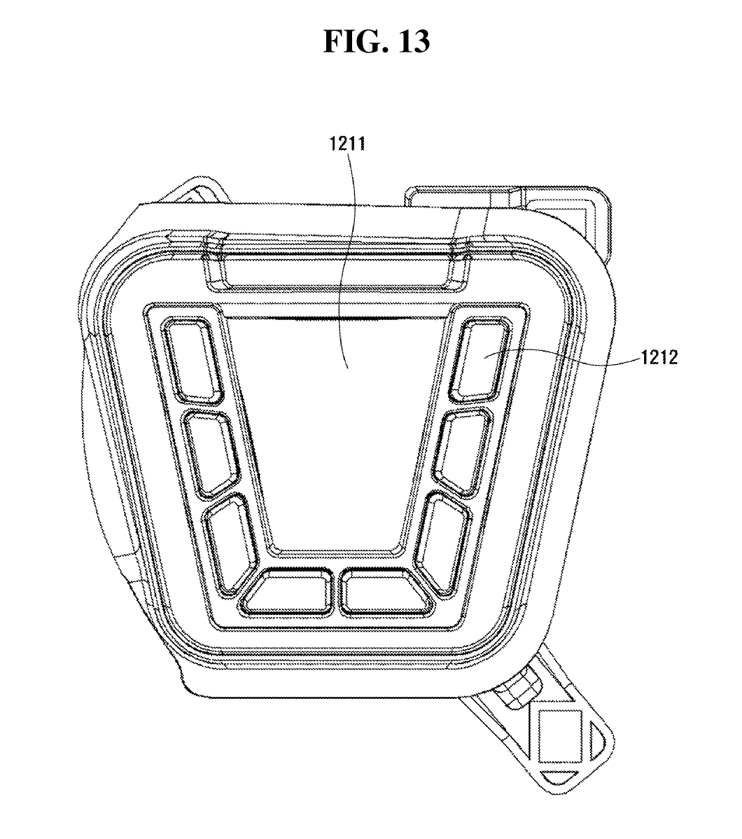

FIG. 13 is an exemplary front view of the automotive lamp 20 according to the second exemplary embodiment of the present invention. An observer of the automotive lamp 20 may perceive the light output portions that form the beam pattern forming part 1211 and the light image forming part 1212 as being separated from each other. Accordingly, the observer may perceive that a separate light source exists for each of the light output portions. The light image forming part 1212 composed of a plurality of light output portions may be placed around the beam pattern forming part 1211. Referring to FIG. 13, the light output portions of the light image forming part 1212 may be placed on the left, right and lower sides of the beam pattern forming part 1211 to form a “U” shape.

However, the arrangement of the light image forming part 1212 is not limited to the “U” shape. The light output portions of the light image forming part 1212 may also be arranged in various shapes including circular and polygonal shapes. For example, the light output portions of the light image forming part 1212 may be arranged along all outer edges of the beam pattern forming part 1211 to form an “O” shape or may be arranged only on the left and right sides to form a “11” shape. The light output portions of the light image forming part 1212 may also be concentrated at the substantial center of the light output part 1210, and the beam pattern forming part 1211 may be disposed at edges of the light output part 1210. In addition, an exit surface of each of the beam pattern forming part 1211 and the light image forming part 1212 may be circular or polygonal. In FIG. 13, each of the beam pattern forming part 1211 and the light image forming part 1212 may have a quadrilateral or trapezoidal exit surface. However, the present invention is not limited thereto, and various exit surfaces can be formed.

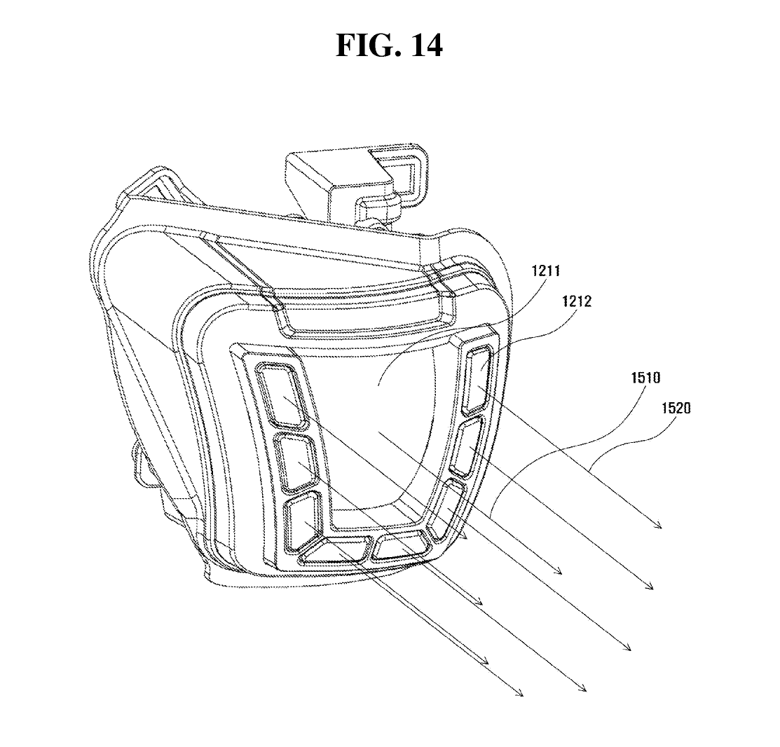

FIG. 14 is an exemplary view of the light output module 1200 according to the second exemplary embodiment of the present invention. Referring to FIG. 14, light rays 1510 and 1520 parallel to the optical axis 1300 may be irradiated through the beam pattern forming part 1211 and the light image forming part 1212. Light reflected by the reflector 1120 may be irradiated to the light output part 1210 mostly in the direction parallel to the optical axis 1300 of the light source 1110. However, light emitted directly from the light source 1110 without being reflected by the reflector 1120 may be irradiated to the light output part 1210 at a certain angle to the optical axis 1300. In addition, of light reflected by the reflector 1120, diffusely reflected light may be irradiated to the light output part 1210 at a certain angle to the optical axis 1300. However, light that transmits through the light output part 1210 at an angle to the optical axis 1300 may cause interference between the light output portions, thus making it difficult for an observer to clearly recognize the boundary between the light output portions.

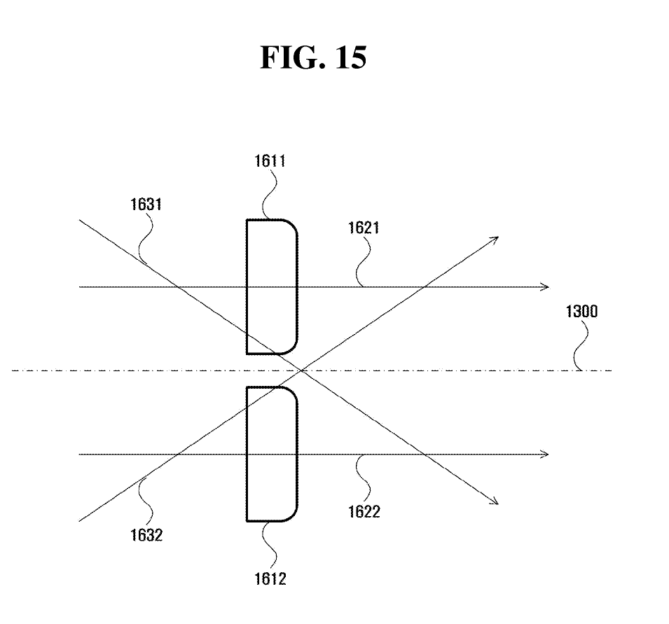

FIGS. 15 through 17 illustrate exemplary light of the light source 1110 which is incident upon the light output part 1210 according to the second exemplary embodiment of the present invention. Referring to FIG. 15, light rays 1621 and 1622 may be configured to transmit through light output portions 1611 and 1612 in the direction substantially parallel to the optical axis 1300, and light rays 1631 and 1632 may be configured to transmit through the light output portions 1611 and 1612 at certain angles to the optical axis 1300.

An observer watching the light rays 1621 and 1622 that transmit through the light output portions 1611 and 1612 in the direction substantially parallel to the optical axis 1300 may perceive that a separate light source exists for each of the light output portions 1611 and 1612. Additionally, an observer watching the light rays 1631 and 1632 that obliquely transmit through the light output portions 1611 and 1612 at certain angles to the optical axis 1300 may have difficulty determining the position of a light source 1110 that corresponds to each of the light rays 1631 and 1632. In addition, the observer may not clearly recognize the boundary between the light output portions 1611 and 1612 due to the interference of light between the light output portions 1611 and 1612.

For the above reasons, the effect that may be obtained using a plurality of light sources may not be obtained to the same degree by using one light source 1110. However, the light blocking member 1220 according to the second exemplary embodiment of the present invention may prevent the interference of light between the light output portions 1611 and 1612, thus enabling an observer to more clearly recognize the boundary between the light output portions 1611 and 1612.

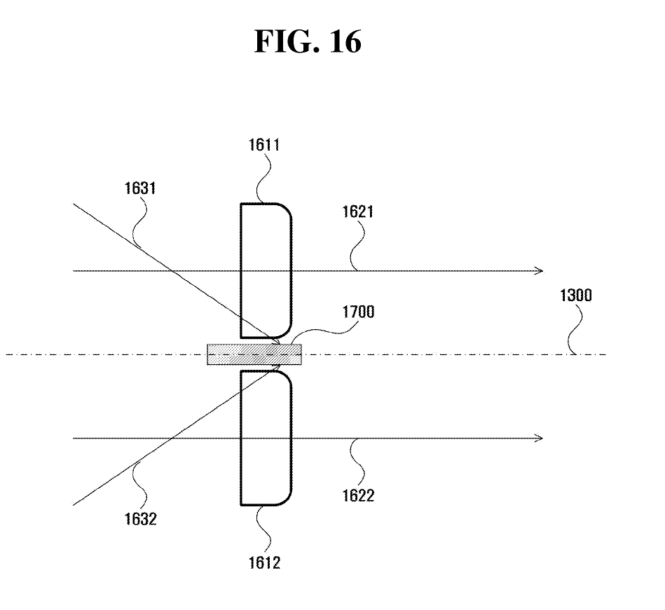

Referring to FIG. 16, a barrier rib 1700 of the light blocking member 1220 may be disposed between the light output portions 1611 and 1612. Thus, the light rays 1631 and 1632 irradiated at certain angles to the optical axis 1300 may be blocked by the barrier rib 1700 from leaking to the exterior. Since the light rays 1631 and 1632 not parallel to the optical axis 1300 may be prevented from leaking to the exterior, an observer may more clearly recognize the boundary between the light output portions 1611 and 1612.

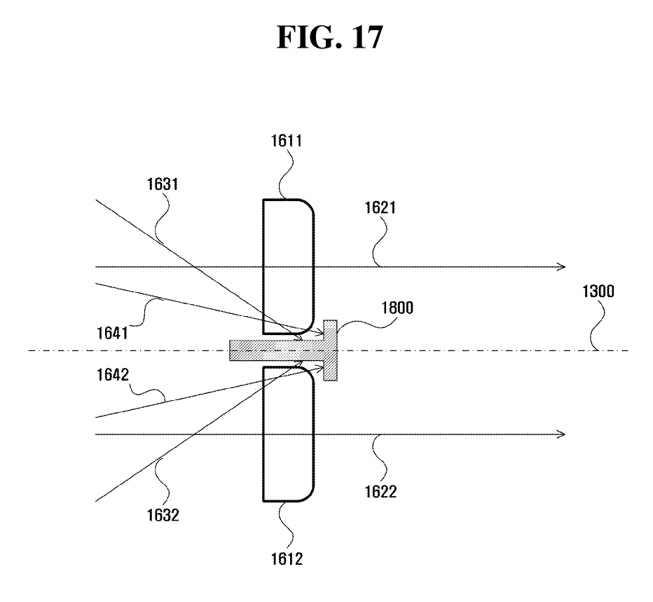

Referring to FIG. 17, a barrier rib 1800 may have a portion that protrudes toward the light output portions 1611 and 1612. The barrier rib 1800 with the protruding portion may be configured to block more light rays 1631, 1632, 1641 and 1642 irradiated at angles to the optical axis 1300. Therefore, the boundary between the light output portions 1611 and 1612 may be recognized more clearly. As described above, the barrier rib 1700 or 1800 of the light blocking member 1220 may be configured to prevent a portion of light incident upon the light output portions 1611 and 1612 at an angle to the optical axis 1300 from leaking to the exterior. Therefore, an observer may observe the light rays 1510 and 1520 irradiated mostly in the direction substantially parallel to the optical axis 1300 as illustrated in FIG. 14.

In FIGS. 16 and 17, the light output portions 1611 and 1612 may be disposed parallel to each other. However, the light image forming part 1212 may also be disposed to protrude further forward than the beam pattern forming part 1211 as illustrated in FIG. 14. Accordingly, the structure may reduce the interference between light that transmits through the beam pattern forming part 1211 and light that transmits through the light image forming part 1212 and thus, allowing an observer to more clearly recognize the boundary between the light output portions 1611 and 1612.

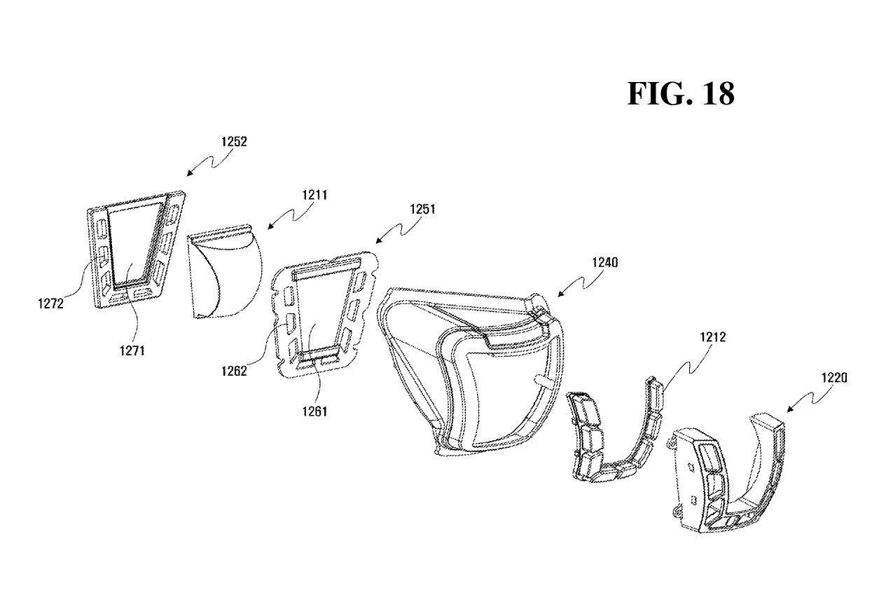

FIG. 18 is an exemplary detailed view of the light output module 1200 according to the second exemplary embodiment of the present invention. Referring to FIG. 18, the light output module 1200 may include the beam pattern forming part 1211, the light image forming part 1212, the light blocking member 1220, a cover member 1240, and fixing members 1251 and 1252. Since the beam pattern forming part 1211, the light image forming part 1212, and the light blocking member 1220 have been described above in detail, a description thereof will be omitted.

The cover member 1240 may be configured to accommodate (e.g., house) the beam pattern forming part 1211, the light image forming part 1212 and the light blocking member 1220 to fix them in a particular position. In addition, the cover member 1240 may be configured to prevent light generated by the light source 1110 from being emitted to the exterior through portions other than the light output portions. The cover member 1240 may also be attached to a vehicle to couple the light output module 1200 to the vehicle. Therefore, when a portion through which the light output part 1210 and the light blocking member 1220 are exposed may be a front surface of the cover member 1240, the shape of a rear or side surface of the cover member 1240 may be determined to correspond to the shape of a portion of the vehicle to which the rear or side surface of the cover member 1240 is attached.

The fixing members 1251 and 1252 may be configured to fix the beam pattern forming part 1211 and the light image forming part 1212 in position. In other words, the first fixing member 1251 may be disposed behind the light image forming part 1212 to fix the light image forming part 1212 by the light blocking member 1220 and the first fixing member 1251. In addition, the second fixing member 1252 may be configured to fix the beam pattern forming part 1211 together with the first fixing member 1251. In other words, the beam pattern forming part 1211 may be inserted and fixed between the first fixing member 1251 and the second fixing member 1252.

An aperture 1261 or 1271 that corresponds to the beam pattern forming part 1211 may be formed in a substantial center of each of the fixing members 1251 and 1252, and a plurality of apertures 1262 or 1272 that correspond to a plurality of light output portions of the light image forming part 1212 may be formed in edges of each of the fixing members 1251 and 1252. A portion of the beam pattern forming part 1211 may be inserted into the aperture 1261 of the first fixing member 1251, and the edges of the beam pattern forming part 1211 may be fixed in position by the first fixing member 1251 and the second fixing member 1252.

The other apertures 1262, 1271 and 1272 may be used to deliver light to each of the light output portions. In other words, the light output portions of the light image forming part 1212 may be inserted into the apertures 1262 formed along the edges of the first fixing member 1251. Thus, light generated by the light source 1110 may be delivered to the light image forming part 1212 through the apertures 1262 and 1272 formed in the edges of the first fixing member 1251 and the second fixing member 1252. In addition, the light generated by the light source 1110 may be delivered to the beam pattern forming part 1211 through the aperture 1271 formed in the substantial center of the second fixing member 1252.

The structure of the light output module 1200 according to the second exemplary embodiment of the present invention is not limited to the above structure. For example, when the beam pattern forming part 1211 and the light image forming part 1212 are formed as a single part, the first fixing member 1251 may be omitted, and the light blocking member 1220 and the cover member 1240 may be formed as a single part.

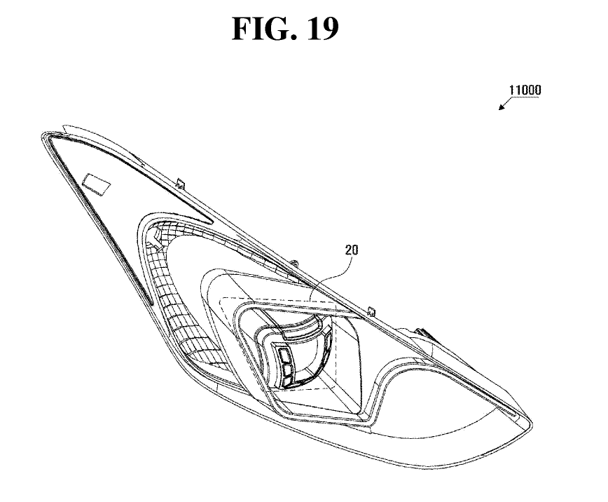

FIG. 19 illustrates an exemplary headlamp 11000 equipped with the automotive lamp 20 according to the second exemplary embodiment of the present invention. The automotive lamp 20 of the present invention is not necessarily installed in the headlamp 11000. The automotive lamp 20 may also be installed on a vehicle separately from the headlamp 11000. In particular, the automotive lamp 20 may be used for purposes other than the purpose of the headlamp 11000, that is, the purpose of securing forward visibility at night. For example, the automotive lamp 20 of the present invention may be used as a reversing light (e.g., a light that is turned on when the vehicle is traveling in a reverse direction).

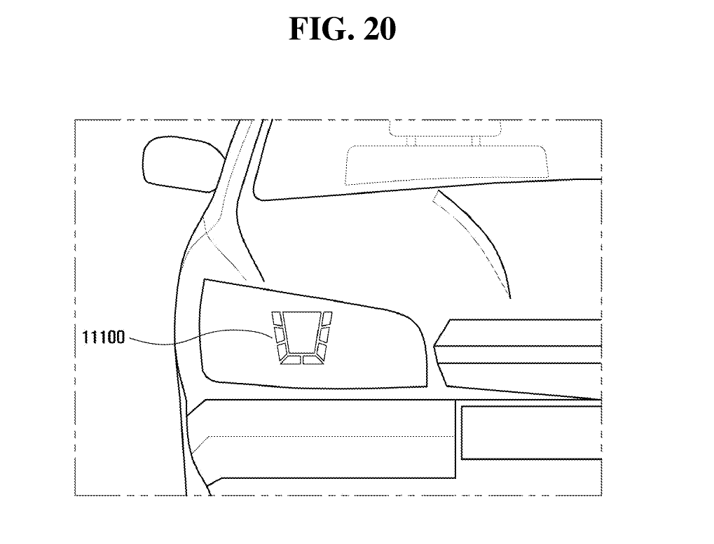

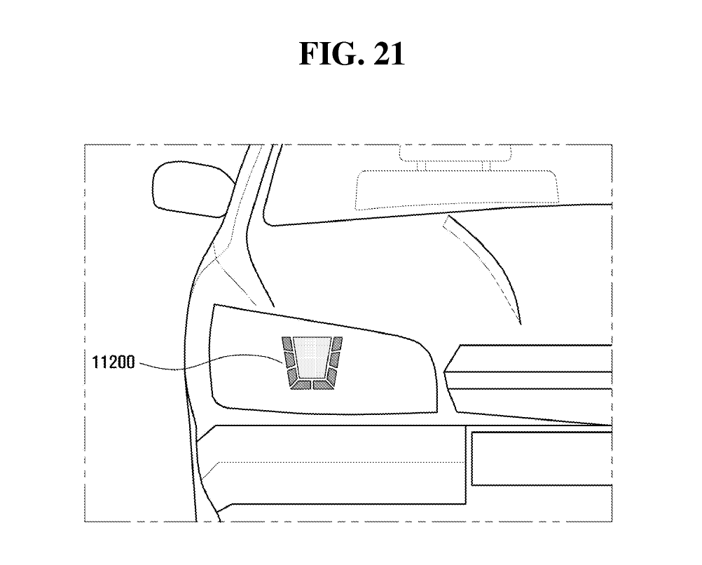

FIGS. 20 and 21 illustrate the exemplary automotive lamp 20 viewed from in front of a vehicle according to the second exemplary embodiment of the present invention. Specifically, FIG. 20 illustrates the automotive lamp 20 turned off, and FIG. 21 illustrates the automotive lamp 20 turned on. An image 11100 of the automotive lamp 20 turned off is not clear, but an image 11200 formed by light that transmits through the beam pattern forming part 1211 and the light image forming part 1212 of the automotive lamp 20 turned on is more clear.

In particular, the luminance of light that transmits through the beam pattern forming part 1211 may be greater than that of light that transmits through the light image forming part 1212. Therefore, the beam pattern forming part 1211 and the light image forming part 1212 may be more clearly distinguished from each other. To further distinguish the beam pattern forming part 1211 and the light image forming part 1212, the color of light that transmits through the beam pattern forming part 1211 and the color of light that transmits through the light image forming part 1212 may be different through filtering as described above.

An automotive lamp according to the present invention provides at least one of the following advantages.

First, a predetermined image or shape may be formed when the automotive lamp is turned on or off.

Second, since a leaked portion of light generated by a light source may be used to form an image, a part for preventing the leakage of the leaked portion may be omitted.

Third, an image that may be formed using a plurality of light sources may be formed using a leaked portion of light generated by one light source. Therefore, a luxurious appearance may be added to a product at a low cost.

Fourth, silicon may be used for a light image forming part. Thus, even when a light source (such as a bulb) that generates substantially high heat is used, high durability of the light image forming part may be ensured.

However, the effects of the present invention are not restricted to the one set forth herein. The above and other effects of the present invention will become more apparent to one of daily skill in the art to which the present invention pertains by referencing the claims.

While the present invention has been particularly shown and described with reference to exemplary embodiments thereof, it will be understood by those of ordinary skill in the art that various changes in form and detail may be made therein without departing from the spirit and scope of the present invention as defined by the following claims. The exemplary embodiments should be considered in a descriptive sense only and not for purposes of limitation.

What is claimed is:

1. A vehicle lamp, comprising:
a light source;
a light image forming part configured to form an image of a predetermined shape using light emitted from the light source; and
a reflector configured to form a beam pattern by reflecting the light from the light source to a certain area and guide the light from the light source to the light image forming part disposed in front of the light source by reflecting the light of the light source to another area.

2. The vehicle lamp of claim 1, wherein a directional angle of the light source with respect to the reflector is determined in view of an irradiation angle range of the light source.

3. The vehicle lamp of claim 2, wherein the light image forming part is shaped as a plate having a predetermined thickness, and side surfaces of the light image forming part are disposed adjacent to edges of the reflector.

4. The vehicle lamp of claim 1, wherein the image includes a surface emission image.

5. The vehicle lamp of claim 4, wherein the light image forming part is shaped as a plate having a predetermined thickness, and the surface emission image is formed by paint applied along a vertical cross section of the plate.

6. The vehicle lamp of claim 5, wherein the image includes a pattern selected from a group consisting of: a linear pattern, a curved pattern, and a polygonal pattern, and a shape of the surface emission image includes a “U” shape.

7. The vehicle lamp of claim 5, wherein the surface emission image is formed by the light from the light source which is incident upon a surface or side surfaces of the plate of the light image forming part.

8. The vehicle lamp of claim 1, wherein the light image forming part is shaped as a plate having a predetermined thickness, and the image is formed by an optic formed on the surface of the plate, wherein the optic is formed by at least one of light refracting patterns and scratches.

9. The vehicle lamp of claim 8, wherein the image is formed by the light from the light source which is incident upon the surface or side surfaces of the plate of the light image forming part.

10. The vehicle lamp of claim 1, further comprising:
a beam pattern forming part configured to receive the light emitted from the light source and form the beam pattern.

11. The vehicle lamp of claim 10, wherein the light image forming part comprised of a plurality of portions is disposed around the beam pattern forming part, and an exit surface of each of the beam pattern forming part and the light image forming part has a circular or polygonal shape.

12. The vehicle lamp of claim 10, wherein a color of light that transmits through the beam pattern forming part is different from a color of light that transmits through the light image forming part.

13. The vehicle lamp of claim 10, further comprising:
a light blocking member configured to block the movement of light between the beam pattern forming part and the light image forming part.

14. The vehicle lamp of claim 10, further comprising:
a first fixing member and a second fixing member, each including an aperture and a plurality of apertures formed in edges thereof.

15. The vehicle lamp of claim 14, wherein a portion of the beam pattern forming part is inserted into the aperture of the first fixing member, edges of the beam pattern forming part are fixed in position by the first fixing member and the second fixing member, and the portions of the light image forming part are arranged along the edges of the first fixing member.

16. The vehicle lamp of claim 1, wherein the light source includes a bulb.

17. The vehicle lamp of claim 16, wherein the light image forming part is made of silicon.
